(19) United States
(12) Patent Application Publication
(10) Pub. No.: US 2018/0057195 A1
(43) Pub. Date: Mar. 1, 2018

(54) QUICK DROP AND DRINK NUTRITION AND MACHINE FOR MANUFACTURING THE SAME

(71) Applicant: Nicholas J. Singer, Irvine, CA (US)

(72) Inventors: Nicholas J. Singer, Irvine, CA (US); Brian Dykema, Orange, CA (US)

(21) Appl. No.: 15/608,886

(22) Filed: May 30, 2017

Related U.S. Application Data
(63) Continuation-in-part of application No. 15/246,842, filed on Aug. 25, 2016.

(51) Int. Cl. B65B 9/20; A23L 2/66; A23L 33/19; B65B 39/00; B65B 51/26; B65D 65/46; B65B 61/06; B65D 75/44; B65D 1/02; B65D 41/02

(52) U.S. Cl. CPC B65B 9/20; A23L 2/66; A23L 33/19; B65B 39/007; B65B 51/26; A23V 2002/00; B65B 61/06; B65D 75/44; B65D 1/0246; B65D 41/02; B65D 65/46

(57) ABSTRACT

The packet for providing nutrients to a person is disclosed. The packet may be inserted into a bottle of water at which time, a film of the packet begins to dissolve and allow the water to seep into the packet. When the water seeps into the packet, the water dissolves the film from the inside out so that the film dissolves from the outside in and inside out to reduce the time required to completely dissolve the film. Moreover, the bottle of water can be closed so that the user can shake the bottle of water and allow the powdered nutrient in the packet to rub against the film and further reduce the time required to completely dissolve the film and also dispersed the powdered nutrient in the water. The powdered nutrient may have a rate of dissolution that is slower than the film so that the powdered nutrient can run and cause friction against the film throughout the entire period of time water bottle was shaken.

### CROSS-REFERENCE TO RELATED APPLICATIONS

This application is a continuation-in-part patent application of U.S. Ser. No. 15/246,842, filed on Aug. 25, 2016, the entire contents of which is expressly incorporated herein by reference.

### STATEMENT RE: FEDERALLY SPONSORED RESEARCH/DEVELOPMENT

Not Applicable

### BACKGROUND

The embodiments described herein relate to a nutritional packet mixable with water to provide nutrition to a person.

Basic sustenance is crucial in mass casualty situations. In order to provide such basic sustenance, large amounts of food must be brought in so that people can sustain their health over a long period of time. Additionally, people who exercise need a quick way of consuming necessary nutrition before and after exercising.

Accordingly, there is a need in the art for an improved method and device for providing nutrition to people.

### BRIEF SUMMARY

The packet disclosed herein contains a powdered nutrient disposed in a tube configured film that can be dissolved in water. The film can dissolve in water in under two minutes when the water is still. As such, the film and the powdered nutrient can be dispersed in the water in under two minutes when the water is still. Moreover, the time for the film to dissolve in water may be faster than the time for the powdered nutrient to dissolve in the same water. By way of example and not limitation, the powdered nutrient may be non-dissolvable or may dissolve at a rate that is slower than the film. This accelerates the rate at which the packet can be dispersed in the water and the mixture consumed by the person. In particular, when the packet is submersed in water, the water begins to dissolve the film. When a portion of the film has dissolved so that water can enter the interior volume of the packet, then the water begins to dissolve the film from the inside out to thereby further dissolve the film faster. The time required to disperse the powdered nutrient in the water and completely dissolve the film and the water may be reduced by shaking the water bottle. By doing so, the powdered nutrient rubs against the film and reduces the time needed to dissolve the film and the water due to friction from the powdered nutrients on the film.

More particularly, a drop and drink nutritional packet allowing a person to drop the nutritional packet into a mouth of a disposable drinking water bottle, wait two minutes or less and drink a nutritious beverage is disclosed. The packet may comprise a tube and a powdered protein nutrient. The tube may have air tight sealed ends and an air tight fin seal along a length of the tube. The tube may define an interior volume. A length of the interior volume may be defined by the tube being between 2 inches to 12 inches long. A circumference of the tube may be sufficiently small so that the tube is insertable lengthwise into the mouth of the water bottle having a diameter of 2 inches or less. The tube may be fabricated from a water dissolvable hydroxypropyl methyl cellulose film so that the film dissolves when the packet is dropped into the drinkable water.

The mouth of the water bottle 12 may have an inner diameter of 2 inches or less (e.g., 1.381″, 1.251″, 1.165″, 1.091″, 0.987″, 0.875″, 0.791″, 0.653″). The mouth of the water bottle 12 is too small that a person cannot remove an object from the water bottle 12 after it has been inserted into the mouth of the water bottle 12. The person cannot insert his or her finger into the water bottle and remove the object. The packet is submersed in the water by inserting the packet through the mouth of the water bottle 12. The packet is sufficiently narrow to fit through the mouth of the water bottle. Also, the packet 12 is sufficiently short so that the entire packet can fit height wise in the water bottle. Nevertheless, the packet can contain sufficient amounts of powdered protein nutrients to provide a nutritious drink to the user. Because the mouth of the water bottle 12 is too small for a person to insert his or her finger into the mouth of the water bottle 12 and remove any object, the packet allows for this situation and does not require the user to remove anything in order to consume the nutritious drink. The packet and anything that is inserted into the water bottle and water is ingestible. The packet is fabricated from a film configured as a tube. The film is dissolvable into the water is a homogeneous solution and the powdered protein nutrient is dispersible in the water as either homogeneously or heterogeneously. Preferably, the time required for the powdered protein nutrient to dissolve, if the powdered protein nutrient does dissolve in water, into the water is greater than the time required for the film to dissolve into the water. Alternatively, the powdered protein nutrient is non-dissolvable and remains in the water as a heterogeneous solution and is sufficiently small so that the person can drink the nutritious drink. The film is dissolved into the water.

The powdered protein nutrient may have a size between 1 μm and 1000 μm to provide for a heterogeneous solution after the tube dissolves in the drinkable water and the powdered protein nutrient is dispersed into the drinkable water. The powdered protein nutrient may have a time to completely dissolve into the water that is greater than a time to for the film to completely dissolve into the water or the powdered protein nutrient being non dissolvable.

The packet and anything associated therewith that is dropped into the drinking water may be dissolvable in drinking water in less than two minutes and suspendable in the drinking water so that the person can drop the packet in water, wait two minutes or less then drink the nutritious beverage.

Everything attached to the packet when the packet is dropped into the drinking water is dissolvable in drinking water in less than 30 seconds with the water being agitated and suspendable in the drinking water so that the person can drop the packet in water, shake the water bottle for at least 30 seconds then drink the nutritious beverage. In particular, the packet and anything associated with packet that is dropped into the drinking water is ingestible by a person. In this regard, the user need not remove anything from the water in order to drink the nutritious drink. Additionally because everything is ingested that is dropped or submersed into the water, a narrow neck bottle may be utilized. If an object had to be removed from the water bottle, then a neck that is narrow (e.g. less than 2 inches, 1.5 inches or 1 inch in diameter) would not allow or would make it more difficult for the person to remove the object from the water bottle. Moreover, after dropping the packet and anything associated with the packet through the mouth of the water bottle and into the water, the user can consume the nutritious drink after two minutes without agitating the water bottle with water. The film will dissolve in the water in under two minutes and that will allow the powdered protein nutrient to be dispersed into the water. The user can consume the nutritious drink after 20 seconds or 30 seconds by shaking the bottle which causes the powdered protein nutrients to rub against the film to accelerate the dissolution of the film into the water.

A time to dissolve the film in still water at 45° F.-50° F. with pH of 7.0 may be two minutes or less. A time to dissolve the powdered protein nutrient in still water at 45° F.-50° F. with pH of 7.0 may be greater than two minutes so that the powdered protein nutrient rubs against the film to decrease a time for the packet to be submersed in water, agitated and consumable to about 30 seconds or less.

The film may have a film thickness between 0.001 inches and 0.010 inches.

The powdered protein nutrient may have a size between about 1 μm to 100 μm.

An interior volume of the tube may be filled to 50% to 80% with the powdered protein nutrient by volume.

An interior volume of the tube is filled with ingredients consisting of the powdered protein nutrient, inert gas, dehumidified air and combinations thereof.

The powdered protein nutrient may be vacuum sealed into an interior volume of the tube.

In another aspect, a method of manufacturing a drop and drink nutritional packet is disclosed. The method may comprise the steps of providing a hydroxypropyl methyl cellulose film being dissolvable in still water at 45° F.-50° F. and having a pH of 7.0; providing a powdered protein nutrient being non-dissolvable or dissolvable in still water at 45° F.-50° F. and having a pH of 7.0 at a time longer than that of the hydroxypropyl methyl cellulose film in still water at 45° F.-50° F. having a pH of 7.0; forming a tube with a hydroxypropyl methyl cellulose film having an airtight sealed lower end portion; filling the tube with powdered protein nutrients so that the powdered protein nutrients is at about 50% to 80% by volume of the packet; sealing a longitudinal edge of the tube; and forming an airtight seal at an upper end portion of the tube.

In another aspect, a method of preparing a nutritious drink is disclosed. The method may comprise the steps of providing a bottle of water with a cap to close a mouth of the bottle of water, the water having a temperature between 33° F.-65° F., and more preferably 45° F.-50° F.; removing a cap of the bottle of water; removing water from the bottle of water; inserting a drop in drink nutritional packet into the bottle of water through the mouth of the bottle of water; closing the mouth of the bottle of water with the cap; and shaking the bottle of water so that powdered protein nutrients in the packet rub against a film of the packet to decrease the time for the film to completely dissolve the film in the water.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a perspective view of a packet and a water bottle;

FIG. 2 is a front view of the packet and water bottle being inserted into the water bottle;

FIG. 3 is a front view of the packet shown in FIGS. 1 and 2;

FIG. 4 is a cross-sectional side view of the packet shown in FIG. 3;

FIG. 5 is a transverse cross-sectional view of the packet shown in FIG. 3;

FIG. 6 is a front view of another embodiment of the packet shown in FIG. 3;

FIG. 7 is a cross-sectional side view of the packet shown in FIG. 6;

FIG. 8 is a transverse cross-sectional view of the packet shown in FIG. 6;

FIG. 9 is a perspective view of a machine for forming the packet;

FIG. 10 is a close-up view of a portion of the machine shown in FIG. 9;

FIG. 11 is a close-up view of another portion of the machine shown in FIG. 9;

FIG. 12 is a close-up view of a further portion of the machine shown in FIG. 9;

FIG. 13 is a cross-sectional view of a film with an ingestible powdered nutrient disposed in a tube formed by the film;

FIG. 14 is a perspective view of another machine for forming the packet;

FIG. 15 is a front view of the machine shown in FIG. 14;

FIG. 16 is a side view of the machine shown in FIG. 14 before the machine forms a horizontal seal with horizontal heaters;

FIG. 17 is a side view of the machine shown in FIG. 14 when the machine forms the horizontal seal with the horizontal heaters and before powdered food product is dropped into a tube configured film;

FIG. 18 is a side view of the machine shown in FIG. 14 when the machine pulls down a tube configured film as the powdered food product is dropped into the tube configured film and cuts the horizontal seal with a cutter;

FIG. 19 is a side view of the machine shown in FIG. 14 when the horizontal heater releases the tube configured film and powdered food product is dropped into the tube configured film and the cutter is opened; and

FIG. 20 is a side view of the machine shown in FIG. 14 when the horizontal heater is traversed upward to start the cycle again.

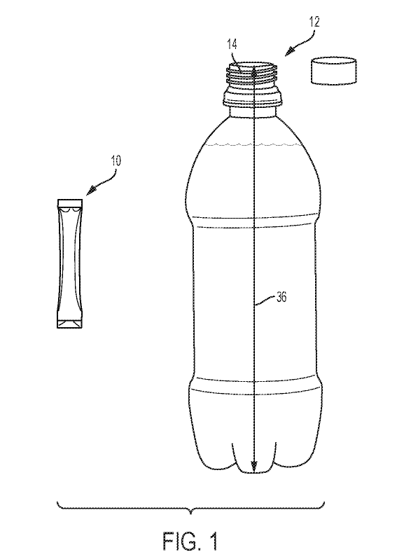

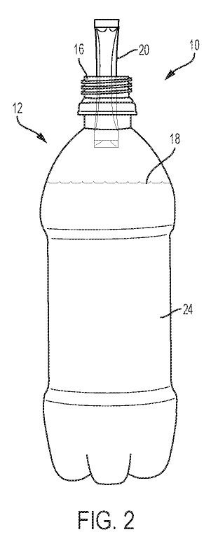

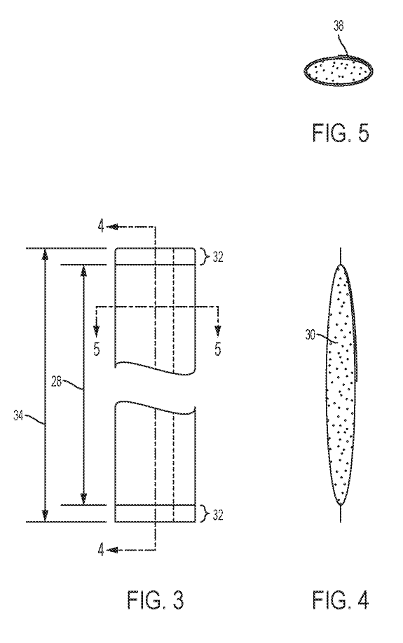

### DETAILED DESCRIPTION

Referring now to the drawings, a drop and drink nutritional packet 10 and a disposable water bottle 12 are shown. The user may remove a cap 14 of the water bottle 12 and insert the packet 10 into a mouth 16 of the water bottle 12. At least a portion of the packet 10 will be submersed under a water line 18 of the water in the disposable water bottle 12. The packet 10 has a tubular configuration and its exterior may be fabricated from a film 20 that dissolves in less than 2 minutes when in contact with still water 24. When the packet 10 is dropped into the water 24 of the water bottle 12, within two minutes, the film 20 dissolves in the water as a homogeneous solution and the powdered nutrients 22 disposed in a tube formed by the film 20 is dispersed into the water as a heterogeneous solution. The packet 10 is entirely ingestible. When the packet 10 is dropped into the water 24, everything that is dropped into the water 24 and is associated with the packet 10 can be ingested by the user. Within two minutes, the user can drink the nutritious beverage without having to retrieve anything from within the water 24 or the water bottle 12 so that the packet 10 allows the user to drop the packet 10 into the water 24 of a disposable water bottle 12 and drink a nutritious beverage in less than two minutes. To speed up the process, the user can also shake the water bottle 12. By doing so, the powdered nutrients 22 disposed in the tube formed by the film 20 rub against the film and further accelerate the dissolution of the film into the water. When shaking the water bottle 12, the user can enjoy a nutritious beverage less than 20 or 30 seconds after dropping the packet 10 into the water and shaking the water bottle 12.

More particularly, the drop and drink packet 10 allows the user to drop the packet 10 into the mouth 16 of the water bottle 12, wait two minutes or less to allow a tube 26 of the packet 10 to dissolve into the water 24 as a homogeneous solution and allow the powdered nutrients 22 to be dispersed into the water 24 as a heterogeneous solution. Within two minutes or less after dropping the packet 10 into the water, the user can drink the nutritious beverage. To reduce the time to less than 30 seconds, the user can shake the water bottle 12 after dropping the packet 10 into the water bottle 12.

The drop and drink packet 10 may define a length 28. The length 28 is a length of an interior volume 30 of the packet 10. Opposed end portions 32 are sealed so as to be airtight. The packet 10 is fabricated from a film material that can bend. When the packet 10 is inserted into the water bottle 12, the end portions 32 can fold over so that should an overall length 34 of the packet 10 be greater than an interior height 36 of the water bottle 12, the end portions 32 can fold over and allow the packet 10 to be fully encased within the water bottle 12.

The length 28 of the interior volume 30 of the packet may be between 2 inches and 12 inches. Preferably, the length of the interior volume is between 3 to 7 inches. The length 28 of the interior volume 30 may be sufficiently short so that the entire packet 10 fits within the water bottle 12 when a cover cap 14 is screwed on to the bottle 12. The packet 10 is not rigid and can bend slightly so that if needed, the packet 10 can be squished into the bottle 12 by forcing the packet 10 into the bottle 12 completely. Even if the tube 26 of the packet 10 breaks when squished into the disposable water bottle, this is not a detriment to the utility of the packet 10 because the goal of the packet 10 is to quickly disperse the powdered nutrients 22 into the water. Breaking the packet 10 would only expedite such goal.

The length 28 of the interior volume 30 of the packet 10 may be sufficiently long so that the interior volume 30 can hold a determined amount of powdered nutrients. By way of example and not limitation, the length 28 of the interior volume 30 of the packet 10 may be sufficiently long to hold 5 g, 10 g, 15 g, 30 g, 60 g or 90 g of powdered nutrients. Other amounts of nutrients are also contemplated including but not limited to any amount between 10 mg and 120 mg.

The packet 10 may also have a seal along fin 38. The seal along the fin 38 extends along a longitudinal edge of the packet 10.The fin seal 38 is airtight which along with the airtight seals on the end portions 32 fully encapsulate the interior contents (e.g. powdered nutrients) so that moisture in the air does not degrade the quality of the powdered nutrients in the packet 10 over an extended period of time. Rather, the airtight seals keep the powdered nutrients fresh over a longer period of time (e.g. about 30 days, 60 days, 90 days).

The film used to fabricate the tube 26 of the packet 10 may be hydroxypropyl methyl cellulose. The hydroxypropyl methyl cellulose film is provided in a thickness sufficient to allow the hydroxypropyl methyl cellulose film to dissolve in still drinking water at a pH of 7 having a temperature of 45° F.-50° F. in less than two minutes. By way of example and not limitation, the thickness of the hydroxypropyl methyl cellulose film may be between 0.001 inch thick and 0.010 inch thick. Hydroxypropyl methyl cellulose is a preferred material for fabricating the film but the other materials are also contemplated. By way of example and not limitation, the film may be fabricated from rice paper, tapioca powder, amylose, amylopectin, silk (fibroin) gelatin, casein, pullulan, guar gum, soybean polysaccharide film, agar-agar, arabinoxylan, alginate sodium, callaneenan film, pectin, hydroxypropyl cellulose film (i.e., HPC film), hydroxypropyl methyl film (HPMC film), carboxymethyl film, decaglycerin monitor myristate, glycerin, crystalline cellulose, hydroxypropyl cellulose or combinations thereof. More particularly, the film may be fabricated from hydroxypropyl methyl cellulose, glycerin, propylene glycol, Oak fiber, PEG 600 (polyethylene glycol 600), polysorbate 80 or combinations thereof. The film may be air impermeable so that when the packet is sealed on the ends and along its longitudinal lengths, no air enters the packet.

The temperature of the drinking water in the disposable water bottle may be 45° F.-50° F. and the pH of the water may be 7. Broadly speaking the temperature of the drinking water may be between 32° F. and 65° F. and yet still allows the film 20 to dissolve in the water as a homogeneous solution and the powdered nutrients 22 to be disbursed into the water as a heterogeneous solution in less than two minutes after submersion of the packet 10 in the water. Moreover, the pH of the water may be between 6.5 to 8.5 and is preferably above 7.0. The thickness of the hydroxypropyl methyl cellulose film may be at its lower range when the temperature of the drinking water is colder than 45° F.-50° F. and the pH of the drinking water is above 7. The thickness of the hydroxypropyl methyl cellulose film may be at its upper range when the temperature of the drinking water is more than 45° F.-50° F. and the pH of the drinking water is below 7. In use, the packet 10 may be distributed to people in a mass casualty situation. The packet 10 provides nutrients to the people affected by the mass casualty situation. Provided that the affected people can source or obtain water, the packet 10 can be dropped into the water and the person can consume a nutritious beverage in less than two minutes. In a mass casualty situation, the water obtained by the affected persons would normally be at room temperature which corresponds to the air temperature. The temperature of the water, if left long enough in a room, will either be equal to the room temperature or slightly lower due to evaporative cooling of the water if the water is held in an open top container. Nevertheless, this provides the general temperature of the water in which the packet 10 may be dropped into in order to provide the person with the nutritious beverage.

The packet 10 may have a film that is dissolvable and formed into a tubular configuration. The ends of the tube may be sealed (i.e., end seals) and the length of the tube (i.e., fin seal) may be sealed as well. This forms an airtight interior volume 30 of the packet 10. The interior volume 30 is filled with a powdered nutrient. The powdered nutrient is sized to be between 1 μm and 1000 μm. The powdered nutrient can be suspended in the water as a heterogeneous solution when dispersed in the water. The powdered nutrient may be provided in a dry state.

When the powdered nutrient is disposed within the tube 26, the interior volume 30 is filled with the powdered nutrient 22 and air. Instead of air, the manufacturing process used to manufacture the packet 10 may insert an inert gas or dehumidified air in order to slow down or eliminate any degradation of the powdered nutrient 22 when the packet 10 is being stored on the shelf. This increases the shelf life of the packet 10. Nevertheless, a gas (e.g. air, inert gas, food preservative gas) may be filled in the interior volume 30. The food preservative gas reduces the presence of oxygen within the interior volume 30 and an increase in nitrogen or carbon dioxide in the interior volume 30. When the packet 10 is filled with air, the packet 10 tends to float on the water. As such, it is also contemplated that the packet 10 may be vacuum packed and sealed so as to remove any air from the interior volume 30 of the packet to encourage the packet 10 to sink down into the water and to further decrease the time to dissolve the film.

When the packet 10 is inserted into the water bottle 12, the packet 10 floats to the water line 18 because of the gas in the interior volume 30 of the packet 10. As long as a portion of the packet 10 contacts the water, such portion will dissolve into the water as a homogeneous solution and eventually allow the powdered nutrients 22 in the packet 10 to be dispersed into the water 24 as a heterogeneous solution. Even if the entire packet 10 is not submerged in the water 24, the contents of the packet 10, namely, the powdered nutrients 22 can be evenly distributed throughout the water 24 in less than two minutes because there are no internal divisions within the interior volume 30 which would require the entire tube 26 to dissolve first before the powdered nutrients 22 is dispersed in the water 24. Rather, as soon as a hole is made in the tube 26, water 24 will seep into the interior volume 30 of the tube 26 and begin to dissolve the film from the inside out to further accelerate dissolving of the tube 26 in the film from which it is made. Additionally, the powdered nutrients 22 inside of the interior volume 30 will begin to mix with the water 24.

When the packet 10 is dropped into the water bottle 12, the packet 10 and anything associated with the packet 10 that are dropped into the water bottle are ingested by the person. Also, tube 26 dissolves into the water as a homogeneous solution and the contents of the tube 26, namely, the powdered nutrient is dispersed and suspended within the water to form a heterogeneous solution. Once the tube 26 has dissolved and the powdered nutrient has been dispersed, the user may drink the nutritious beverage without having to remove anything from the water 24 before drinking the beverage. Everything within the nutritious beverage is ingestible by the person.

Although the powdered nutrient has been described as forming a heterogeneous solution with the water, it is also contemplated that the powdered nutrient may also dissolve in the water but the time required to dissolve the powdered nutrient may be longer than the time required to dissolve the film. In order to accomplish this relative time for dissolving the film and the powdered nutrient, the thickness of the film and the size of the powder of the nutrient may be increased or decreased in order to account for the respective times to dissolve the film and the powdered nutrient. The powdered nutrient can be non-dissolvable or capable of being dissolved in water but dissolve very slowly so that effectively the powdered nutrient forms a heterogeneous solution with the water at the time the user consumes the mixed drink. For example, the powdered nutrient can dissolve in the water at such a slow rate so that it takes about five minutes for the powdered nutrient to completely dissolve while it takes about two minutes for the film to dissolve in still water at 45° F.-50° F. with the pH of 7 so that at the time of consumption, the powdered nutrient is consumed by the user when it is dispersed in the water as a heterogeneous solution.

Other respective times for dissolving the film and the powdered nutrient are also contemplated. For example, the time required to dissolve the film into the water may be equal to the time required to dissolve the powdered nutrient into the water. In this situation, when the packet is submersed in water, the water begins to dissolve the film. Once a hole is formed through the film, water enters the film and begins to dissolve the film from the inside out. After waiting about two minutes without agitating the water, the film is dissolved in the water and the powdered nutrient is also dissolved in water or almost completely dissolved based on the delay in time because the water had to dissolve through the film for the water to make contact with the powdered nutrient. Moreover, if the water is agitated by closing the water bottle and shaking the water bottle, the undissolved powdered nutrient rubs against the film and decreases the time it takes for the film to dissolve into the water. The friction created by the powdered nutrient rubbing against the film when shaking the bottle reduces the time for the film to dissolve into the water. In this regard, the drink may be provided in less than 30 seconds. In other words, by shaking the water bottle, the film may be dissolved into the water as a homogeneous solution and the powdered nutrient may be dispersed into the water is a heterogeneous solution or a homogeneous solution depending on the time for the powdered nutrient to dissolve into the water due to the size of the powder of the nutrient.

It is also contemplated that the time required to dissolve the film into the water may be greater than the time required to dissolve the powdered nutrient into the water.

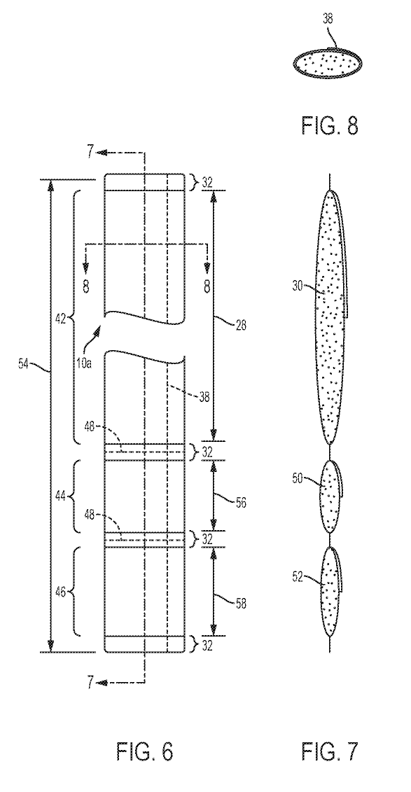

Referring now to FIGS. 6-8, the packet 10a is shown. The packet 10a is different from the packet 10 shown in the prior figures in that the packet 10a has multiple compartments 42, 44, 46. The packet 10a is shown as having three compartments 42, 44, 46 but it is also contemplated that the packet 10a may have two compartments or more than three compartments. The compartment 42 is the first compartment and defines the first interior volume 30 discussed above in relation to packet 10. The packet 10a is shown as having two additional compartments 44, 46 which are disposed sequentially after the compartment 42. The two additional compartments 44, 46 may optionally be detachable from the main compartment 42 prior to submersing the packet 10a into the water.

The compartments 44, 46 may have other food products that may be complementary in taste with the food product disposed within the compartment 42. The compartments 42, 44, 46 may be separated by horizontal seals 32 which may have a perforation 48 used to separate the compartments 42, 44, 46 apart from each other as desired. The perforations 48 extend across the entire width of the packet 10 namely along the horizontal seals 32. The perforations 48 may be utilized to detach either one or both of the compartments 44, 46. Similar to the packet 10, the end portions may also have seals 32. The compartments 42, 44, 46 define an interior volume 30, 50, 52.

A length 54 of the packet 10a may be greater than an interior height 36 of the water bottle 12. In that case, when the packet 10 is inserted into the water bottle, the packet 10a may bend at the central horizontal seals 32 between compartments 42, 44 and compartments 44, 46. Preferably, length 28, 56, 58 is shorter than the interior height 36 of the water bottle 12. Additionally, the length 56 of the central compartment 44 is smaller than an interior diameter of the water bottle 12 so that the packet 10a can be folded into a zigzag pattern within the bottle 12 as the packet 10a is being folded into and disposed within the water bottle 12.

Interior volumes 50, 52 of the compartments 44, 46 may be filled with a powdered food product that is complementary to the powdered food product disposed within the interior volume 30 of the first compartment 42.

The packet 10a also allows the user to drop the packet 10a into the water bottle 12 through the mouth of the water bottle 12. The user waits two minutes or less and allows the tube of the packet 10 to dissolve into still water as a homogeneous solution and allows the powdered nutrients 22 disposed within the first compartment 42 and the powdered food product within the second and third compartments 44, 46 to be dispersed within the water as a heterogeneous solution. This all happens within two minutes or less after dropping the packet 10 into still water so that the user can drink a nutritious beverage within two minutes. To reduce the time it takes for the user to drop the packet 10 into the water and drink the nutritious beverage, the user may close the bottle and shake it in order to allow the powdered nutrient to further act as mechanism for rubbing against the film and reducing the time it takes for the film to dissolve into the water and allow the powdered nutrient to be dispersed into the water.

The length 28, 56, 58 of the interior volume 30, 50, 52 may be between 2 inches and 12 inches. Preferably, the length 26, 56, 58 of the interior volume 30, 50, 52 may be between 3 to 7 inches. The compartments 42, 44, 46 is not rigid and can bend slightly so that if needed, the packet 10a can be squished into the bottle 12 by forcing the packet 10a, and more particularly the compartments 42, 44, 46 into the bottle 12 completely. Even if the tube 26 of the packet 10a breaks, when squished into the disposable water bottle 12, this is not a detriment to the utility of the packet 10a because the goal of the packet 10 is to quickly disburse the powdered food products within the compartments 42, 44, 46 into the water.

Similar to the packet 10, the packet 10a may also have the seal along fin 38. The fin seal is airtight which along with the airtight seals of the end portions 32 and the horizontal seals 32 to fully encapsulate the interior contents (e.g. powdered food products) within the compartments 42, 44, 46 so that moisture in the air does not degrade the quality of the powdered food products within the compartments 42, 44, 46 over an extended period of time.

The film used to fabricate the tube 26 of the packet 10a may be hydroxypropyl methyl cellulose. The hydroxypropyl methyl cellulose film may be provided in a thickness sufficient to allow the hydroxypropyl methyl cellulose film to dissolve in still drinking water at a pH of 7 having a temperature of 45° F.-50° F. in less than two minutes. By way of example and not limitation, the thickness of the hydroxypropyl methyl cellulose film may be between 1 thousands of an inch (i.e., 0.001″) and 10 thousands of an inch (i.e., 0.010″).

The temperature of the drinking water in the disposable water bottle 12 may be 45° F.-50° F. in the pH of the water may be 7. Thickness of the hydroxypropyl methyl cellulose film may be at a lower range when the temperature of the drinking water is colder than 45° F.-50° F. and the pH of the drinking water is below 7. In use, the packet 10a may be distributed to people in a mass casualty situation. The packet 10a provides nutrients to people affected by the mass casualty situation. The packet 10a can be dropped into the water and the person can consume a nutritious beverage in less than two minutes. In a mass casualty situation, the water obtained by the affected person would normally be at room temperature which corresponds to the air temperature or slightly less if the container holding the water has an open top.

When the packet 10a is inserted into the water bottle 12, the packet 10a may float to the water line 18 because of the gas in the interior volume 30, 50, 52 of the compartments 42, 44, 46 of the packet 10a. As long as a portion of each of the compartments 42, 44, 46 of the packet 10a contacts the water, such portion will dissolve into the water as a homogeneous solution and allow the powdered food product in each of the compartments 42, 44, 46 of the packet 10a to be dispersed into the water 24 as a heterogeneous solution. Even if the entire compartment 42, 44, 46 of the packet 10a is not each fully submerged in the water, the contents of the packet 10a, namely, the powdered nutrients 22 in the compartment 42 and the powdered food products in the compartments 44, 46 can be evenly distributed throughout the water 24 in less than two minutes because the water will dissolve a portion of the compartments 42, 44, 46 and allow water to seep into the compartments 42, 44, 46 and begin to dissolve the dissolvable film from the inside out. At this point, the water dissolves the external film both from the outside in and the inside out directions.

When the packet 10a is dropped into the water bottle 12, the packet 10a and anything associated with the packet 10a into the water bottle 12 may be ingested by the person. The packet 10a is the only thing that is dropped into the water of the bottle 12. Also, the tube 26 dissolves into the water as a homogeneous solution and the contents of the tube, namely, the powdered nutrients and the powdered food products are dispersed and suspended within the water to form a heterogeneous solution. Once the tube 26 of the packet 10a has dissolved and the powdered nutrients and the powdered food products have been dispersed into the water, the user may drink the nutritious beverage without having to remove anything from the water 24 before drinking the beverage. Everything in the nutritious beverage may also be ingested by the person. The time it takes for the user to drop the packet 10a into the water bottle and drink the nutritious beverage may be reduced by closing the water bottle and shaking the water bottle to allow the powdered nutrient to also rub against the film and decreased the time it takes for the film to completely dissolve into the water.

The packet 10, 10a is filled with a powdered nutrient. As discussed above, the powdered nutrient has a granularity of about 1 μm to 1000 μm. The powdered nutrient may be dispersed in the water as a heterogeneous solution. The powdered nutrient may be of a form that does not dissolve in the water. However, it is also contemplated that the powdered nutrient may take a longer time to dissolve in water compared to the dissolvable film. For example, if the film dissolved in water in X seconds, then the powdered nutrient may dissolve in water in X+1 seconds. More particularly with respect to the packet 10, 10a, the powdered nutrient may completely dissolve in water after two minutes of being submersed in still water. The two minutes time period for the film to dissolve in water is for water that remains still and is not agitated. However, when the water is agitated, the time for the film to dissolve in water is significantly reduced. In particular, when the packet 10, 10a is immersed in water, the packet may float to the top of the water line. The portion of the packet 10, 10a which is submersed in water begins to dissolve. Once the water has dissolved the portion of the packet 10, 10a so that water can enter the interior volume, the water begins to seep into the interior volume. At this time, the water begins to dissolve the film from the inside out and not only from the outside in as the process of dissolving initially started. If the water is agitated, then the water covers more of the film to thereby speed up the rate at which the film is dissolved and also the powdered nutrient which has not dissolved creates friction with the film to further help the film dissolve in the water.

The water may be agitated after the packet 10, 10a is submersed in water by closing the cover of the water bottle. In order to consume the powdered nutrient disposed in the packet 10, 10a, the user opens the water bottle and empties a portion of the water to allow room for the packet 10, 10a to be inserted into the water bottle so that water does not overflow out of the water bottle when the packet 10, 10a is inserted into the water bottle. Once the packet 10, 10a is inserted into the water bottle, the cover may be screwed back onto the opening of the water bottle to close the water bottle. Immediately, the water begins to dissolve the film. The user may shake the water bottle back and forth so that the water covers all of the film ones. Moreover, once the water dissolves through at least a portion of the film of the packet 10, 10a, the water seeps into the interior volume of the packet and begins to dissolve the film from the inside out. Additionally, due to the shaking of the water bottle, the powdered nutrients rub against the film to further decrease the time for the film to be completely dissolved homogeneously into the water. Since the powdered nutrients takes a longer time to dissolve into the water completely than the film or the powdered nutrient does not dissolve in water, the powdered nutrient acts to dissolve the film by rubbing against the film or impacting the film until the film is completely dissolved.

As discussed above, the powder of the nutrient may have a size of about 1 μm to about 1000 μm. Preferably, the size of the powder of the nutrient may be small enough so that even if the powder of the nutrient is not dissolved or become smaller once it is immersed in the water, as long as the powder is dispersed heterogeneously into the water, a full grown adult can drink the heterogeneous solution of powdered nutrient. However, it is also contemplated that the size of the powder of the nutrient may be sufficiently large so that a full grown adult cannot drink the resulting heterogeneous solution provided that the powder of the nutrient remains the same. In this case, when the size of the powder of the nutrient is larger than the size that a full grown adult can drink as a heterogeneous solution, the powder of the nutrient may be dissolvable so that within about 30 seconds to two minutes, the size of the powder of the nutrient is small enough so that the heterogeneous mixture of the powdered nutrient can be consumed by the person.

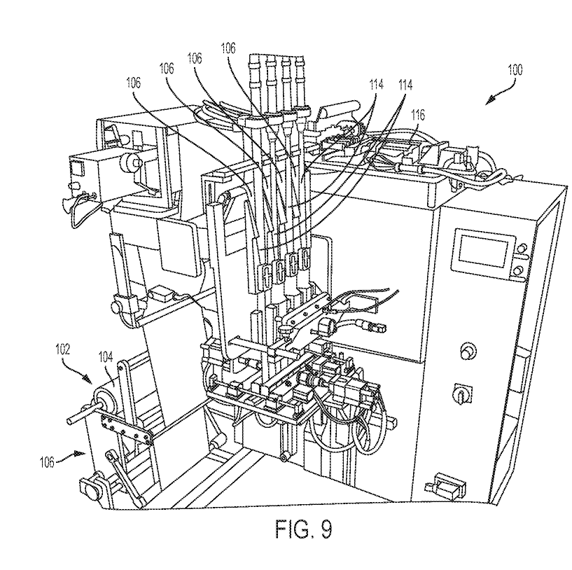

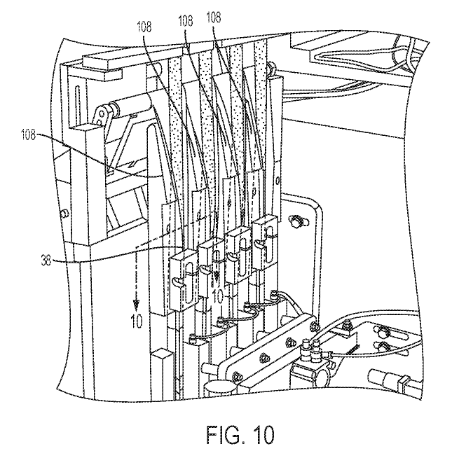

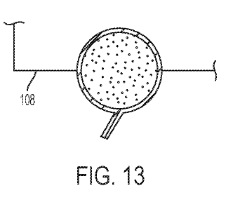

Referring now to FIGS. 9-13, a machine 100 for forming the packets 10, 10a is shown. The machine 100 may have a film loader 102 which holds a roll of film 104. As discussed above, the roll of film 104 may be a roll of hydroxypropyl methyl cellulose film. The roll of film 104 is fed through a series of tensioners 106 until it is slitted into four even strips 106. The film 104 is shown as being divided into four even strips 106 but it is also contemplated that the roll of film 104 may be divided into two or more strips 106 (e.g. eight strips) and it is also contemplated that the roll of film 104 may be sufficiently narrow to support one strip 106. After the width of the roll of film 104 is cut down to size, the strips are folded so as to form a tube configuration is shown in FIG. 10. The strips 106 are folded with a die 108, as shown in FIGS. 10 and 13.

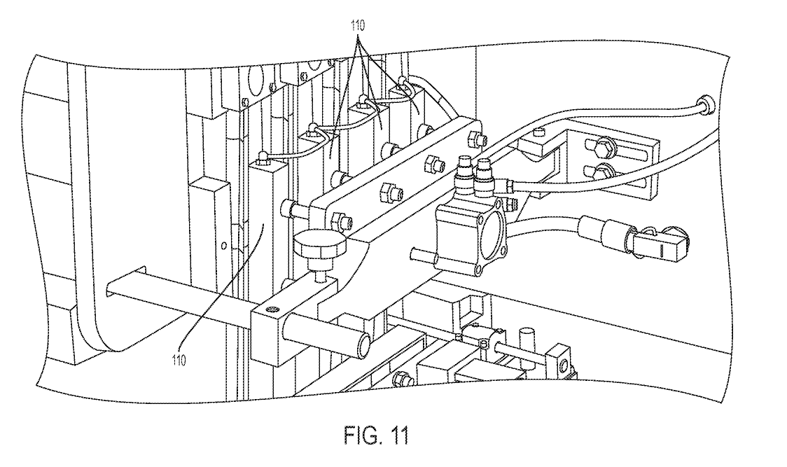

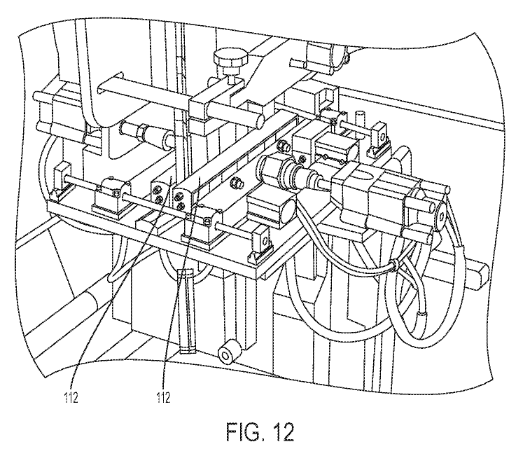

After the film is folded into a tube configuration, a heat seal forms a seal at the fins 38 along the longitudinal length of the tube configured strips 106. The heat is generated with heater 110, as shown in FIG. 11. After the end seal is formed, the end seals 32 are formed with horizontal seal bars 112 as shown in FIG. 12. The seal bars 112 forms the upper end seal of the lower packing 10, 10a and the lower end seal of the upper packet 10, 10a. The horizontal seal bars 112 may also be fitted with a perforator in order to create perforations 48 at the horizontal seals 32 between the compartments 42, 44 and compartments 44, 46. After the seal 32 is formed, the powdered food product is pumped into the tubular formed strips 106 via conduits 114. Pump 116 pumps the powdered food products into the conduits 114 and drops a specific amount of powdered food products into the tubular configured strips 106 as shown in FIG. 13. The horizontal seal bars 112 form the end seals 32 and also slits the upper and lower packets 10, 10a when appropriate and also forms only a perforations 48 when appropriate as well.

By way of example and not limitation, if the packet 10a has two or more compartments as shown in FIGS. 6-8, then the horizontal seal bars 112 seal the middle portion 32 and may optionally perforate the middle portion 32. At the end portions 32, the horizontal seal bars 112 seal the packet but also cut the packet to manufacture individual packets 10a.

As discussed herein, the packet 10, 10a contains powdered nutrient. The powder nutrient may be a powder protein nutrient. However, it is also contemplated that other powder nutrients which are not protein may be disposed in the packet 10, 10a. By way of example and not limitation, the powder nutrient may be protein formulations, carbohydrates, fats, vitamins, minerals, sweeteners, caffeine or combinations thereof. Additionally, these alternative powder nutrients may share the same characteristic as that of the powder nutrient discussed above in relation to all aspects of the powder nutrient including but not limited to time to dissolve, non-dissolvability, and rate of dissolving. Moreover, these alternative powder nutrients may have a relative time to dissolve with respect to the film and behave the same way as the powder nutrient in decreasing the time to dissolve the film into the water.

The interior volume 30 of the compartments of the packet 10 may have a volume x. The powder nutrient may fill the interior volume 30 to a certain percentage less than 100% so that the powder nutrient moves about within the interior volume 30 if the water bottle is shaken. Such movement creates friction against the film and decreases the time for the film to dissolve into the water. In this regard, the powder nutrient may fill the interior volume 30 at about a 50%, 60%, 70% level with respect to the volume x.

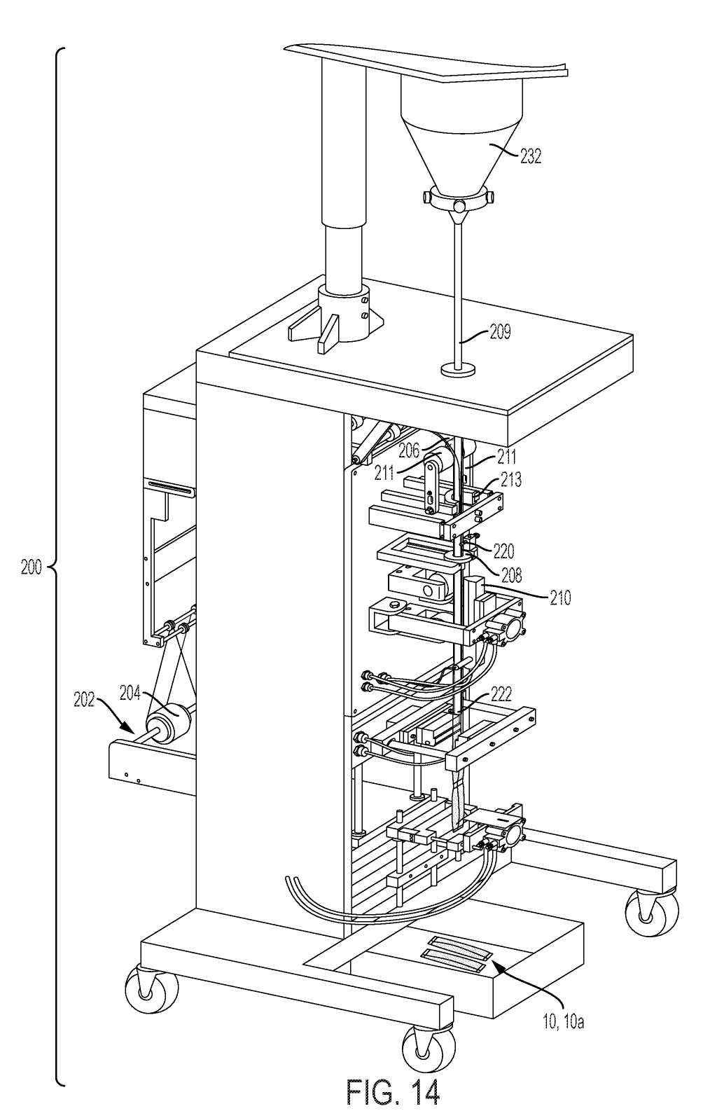

Referring now to FIGS. 14-20, a machine 200 which may be identical to machine 100 for forming the packets 10, 10a is shown except for the following features discussed and shown in relation to FIGS. 14-20. The machine 200 may have a film loader 202 which holds a roll of film 204. The film loader 202 may have a rod 300 that can be removed from a frame of the machine 200 so that the roll of film 204 can be mounted to the rod 300 when needed. As discussed above in relation to roll of film 104, the roll of film 204 may be a roll of hydroxypropyl methylcellulose film. Although the various aspects and embodiments have been described in relation to a roll of film fabricated from a hydroxypropyl methyl cellulose film, other materials are also contemplated including but not limited to rice paper, tapioca powder, Amylose, Amylopectin, Silk (Fibroin) Gelatin, Casein, Pullulan, Guar gum, Soybean polysaccharide film, Agar-agar, Arabinoxylan, Alginate sodium, Callaneenan film, Pectin, Hydroxy propyl cellulose film (i.e., HPC film), Hydroxy propyl methyl film (i.e., HPMC film) Carboxymethyl cellulose film, Carboxymethyl film, Decaglycerin monitor myristate, Glycerin, Crystalline cellulose, Hydroxypropylcellulose or combinations thereof. An exemplary combination may be Decaglycerin monitor myristate, Glycerin, Crystalline cellulose, Hydroxypropylcellulose which is provided in film form with a thickness of about 0.004 inches thick. The thickness may have a range between 0.001 and 0.010 inches. The roll of film 204 may be fed through a series of tensioners (not shown) located at the rear of the machine 200. The tensioners allow the film 104, 204 to be pulled off of the roll 204 and feed the film into the machine 200. In FIG. 14, the film is not split into multiple strips 206 because the strip width is pre-sized to form only one packet 10, 10a. However, it is contemplated that film 204 may be sufficiently wide to be slit into multiple strips similar to machine 100 so that the machine 200 can be used to fill and manufacture packets at the same time at a rate similar to machine 100.

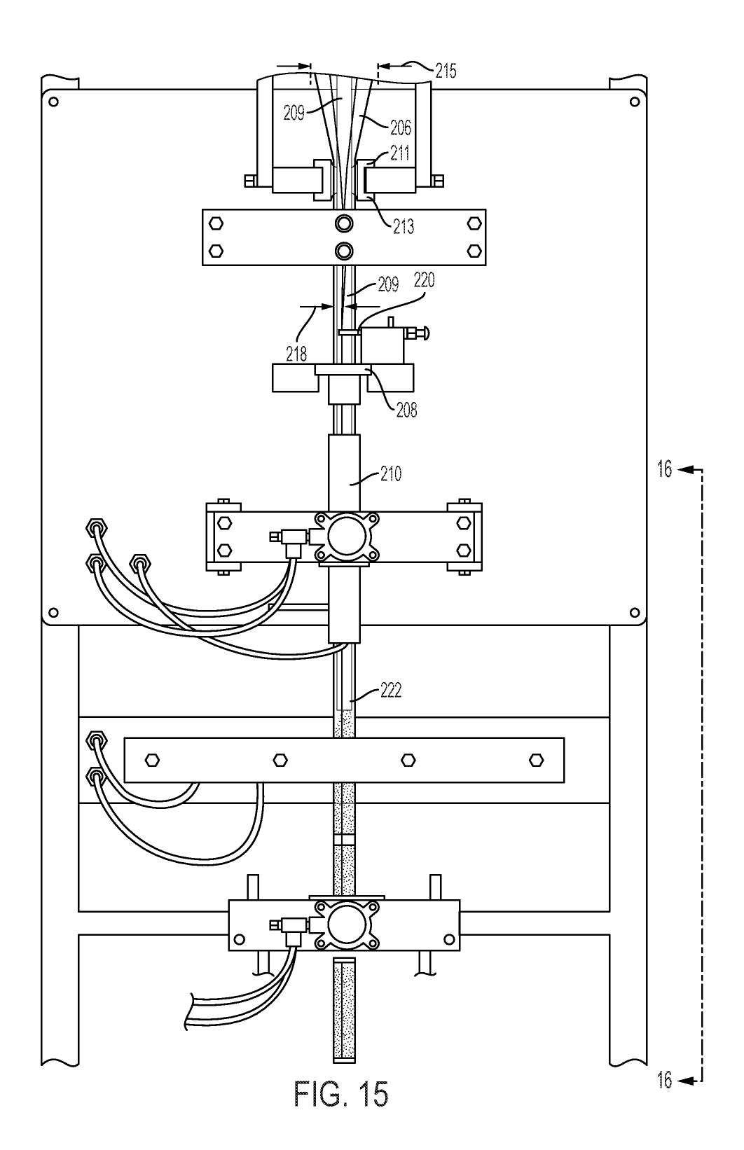

The strip may be folded so as to form a tube configuration. The strip 206 may be completely folded within a die 208 and around tube 209. The tube 209 is disposed within and sized to an inner circumference of the die 208 so that the film or strip may retain its tubular configuration when the vertical fin seal is made. More particularly, when the strip 206 is fed to the front of the machine through the tensioners, as shown in FIG. 15, the strip 206 may be bent against and around the tube 209 with the roller 211. The roller 211 may partially hug the tube 209 so that the film or strip 206 is partially folded around the tube 209. The strip 206 begins to form into a round tube with the aid of the roller 211 and the tube 209. The roller 211 pushes the strip 206 around the tube 209. The strip 206 is further conformed or shaped around the tube 209 with the die 208 that fully circumscribes the entire tube 209. Hydroxypropyl methylcellulose film with a thickness in the lower range of the 0.001 inches to 0.010 inch range may be flimsy in that a 1 inch square piece of the film would could not be supported vertically if held vertically at its bottom edge portion. For example, a 0.001 inch thick film of hydroxypropyl methylcellulose 1 inch square would fold over when held vertically at the bottom edge portion of the square piece of film. The roller 211 helps to maintain the shape of the film as it is being formed into a tubular configuration even when the film is flimsy and cannot support its own weight, as discussed.

The width 215 of the strip 206 when the strip 206 is flat without being curved by roller 211 may be greater than a circumference of the tube 209. This allows enough room for opposed edge portions 218 of the strip 206 to overlap and be vertically heat sealed together to form the vertical fin seal. The opposed edge portions 218 may be held down and in place with a needle 220. The needle 220 may be adjusted to help position the opposed edge portions 218 of the strip 206. Before the strip 206 enters the die 208, the strip 206 fully circumscribes the tube 209 and the opposed edge portions 218 are folded over each other which will form the fin seal.

A vertical heater 210 may be pressed against the tube 209 on the opposed edge portions 218. The strip 206 may be coated with a heat activated adhesive so that the opposed edge portions 218 are sealed together when the vertical heater 210 applies heat to the opposed edge portions 218. The sealed edge portions 218 define the fin seal.

With the opposed edge portions 218 sealed together, the strip 206 forms a tubular configuration. When the machine 200 is running, the machine 200 serially produces a series of packets 10, 10a.

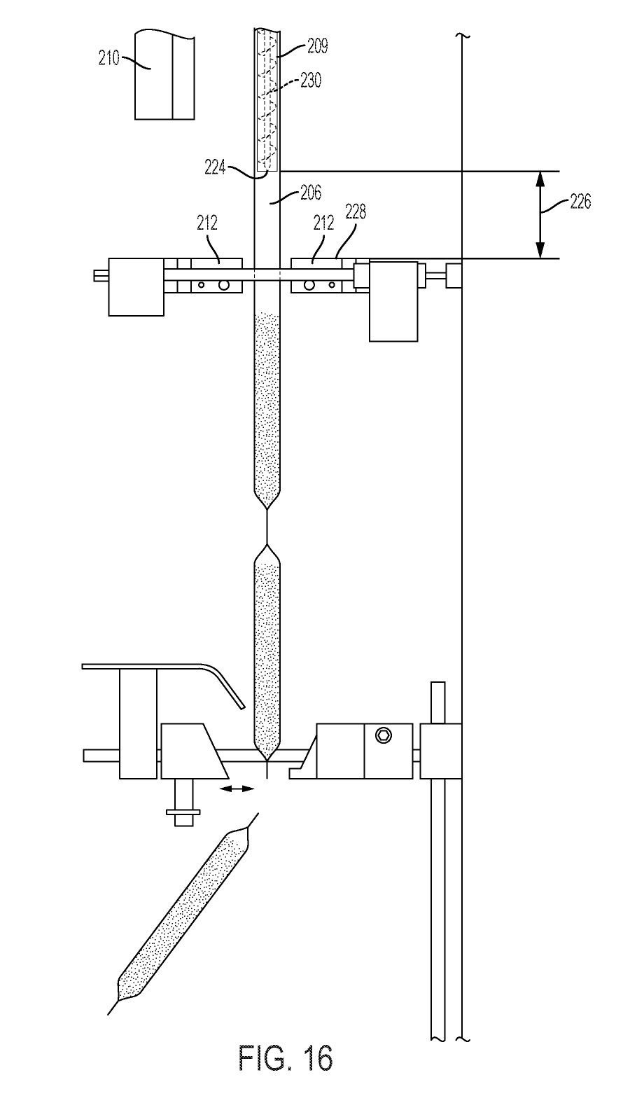

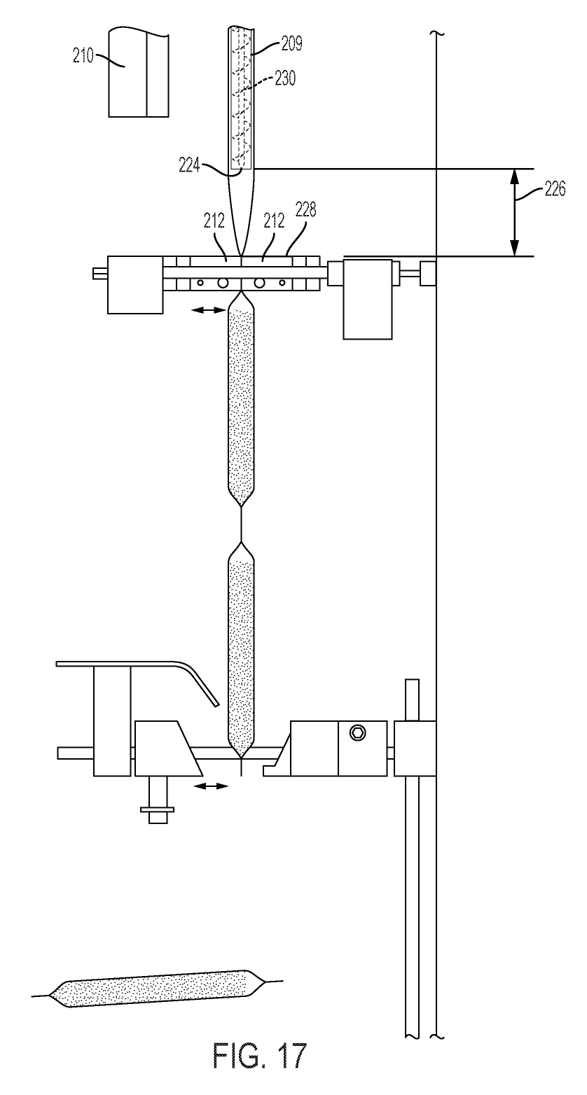

In the position shown in FIG. 16, horizontal heaters 212 are in the retracted position and do not touch the tube configured strip 206. The tube 209 has a distal end 224. The distal end 224 of the tube 209 is very close to the horizontal heaters 212. In this regard, a distance 226 between the distal end 224 of the tube 209 and the top 228 of the horizontal heater 212 may be between ½ inch and 5 inches. Preferably, the distance 226 is between about 0.5 inches to 4 inches and more preferably between 1 inch to 2.5 inches. When the horizontal heaters 212 clamp down on the strip 206, as shown in FIG. 17, the film forms a wedge shaped tube that spans distance 226 between the top 228 of the horizontal heaters 212 and the distal end 224 of the tube 209. The wedge shape of the tubular configuration prevents the powdered food product from hitting a flat bottom surface and mitigates the powdered food product from becoming airborne. The powdered food product may have a mesh size between 80 mesh and 200 mesh. The interior surfaces of the wedge shaped tube allow the powdered food product to slide down to the lower apex of the wedge shaped tube. Moreover, the short distance 226 does not allow the powdered food product to gain speed so that when the powdered food product is stopped, the powdered food product does not form a dust cloud. Because the size of the powder of the powdered food product is so small, the powdered particulates may have a tendency to become airborne when transferred or disturbed. The short distance 226 mitigates the powdered food product from becoming airborne as the powder is flowing down the sides of the wedge shaped tube. The short distance 226 reduces the amount of time that the powdered food product is in free fall and thus speed in order to fill the tubular configured film. When the horizontal heaters 212 create the horizontal seal, as shown in FIG. 17, an auger 230 begins to rotate and allow the powdered food product to flow through the tube 209 and out of the distal end 224 into the tubular configured strip or film. The distal end of the auger is close to the distal end 224 of the tube 209. In this regard, the augur allow the powdered food product to fill the tube 209 up to and close to the distal end 224 of the tube 209. The powdered food product does not drop from the hopper 232 but begins to drop down closer to the distal end 224 of the tube 209 and more particularly, the distal end of the auger 230 which would be at or slight above the distal end 224 of the tube 209.

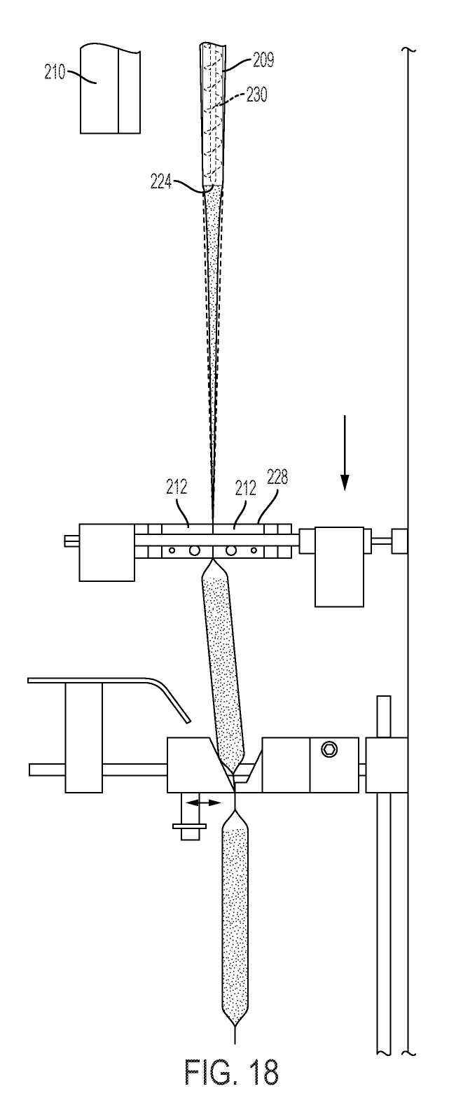

After the powdered food product begins to flow out of the distal end 224 of the tube 209 because of the turning of the auger 230, the horizontal heaters 212 which are in the closed position pull the strip downward, as shown in FIG. 18. The strip between the top 228 of the horizontal heaters 212 and the distal end 224 of the tube 209 is increasing. Since air may not be allowed to freely flow into the tubular configured strip therebetween 228, 224, a slight vacuum may be created which may curve the sides of the wedge shaped tube inward as shown in FIG. 18. In FIG. 18, the dash lines between the distal end 224 and the top 228 of the horizontal heaters is a straight line between the tube 209 and the horizontal seal formed by the horizontal heaters. The film is shown as being curved inward due to the slight vacuum formed. The powdered food product is continually fed into the wedge shaped tube while the horizontal heaters 212 pull the strip down. Because the powdered food product contacts the inwardly curved sides of the tubular configured strip, the powdered food product is less likely to form a dust closud and slide down the sides of the film/strip. The curved sides further mitigate the potential of the powdered food product from becoming airborne in the tube and excessively contaminating the adhesive layer which might prevent a good seal from forming horizontally when the horizontal heaters 212 press against each other to form the horizontal seal. The powdered food product is continually fed into the tubular configured strip by rotating the auger 230 until a predetermined amount of powdered food product is filled in the wedge shaped tube.

When the predetermined amount of powdered food product is disposed within the tubular configured strip, the auger 230 stops rotating and powdered food product stops exiting the tube 209. Additionally, a knife mechanism 234 cuts the strip at some point where the horizontal heaters 212 created a horizontal seal to create the packet 10, 10a.

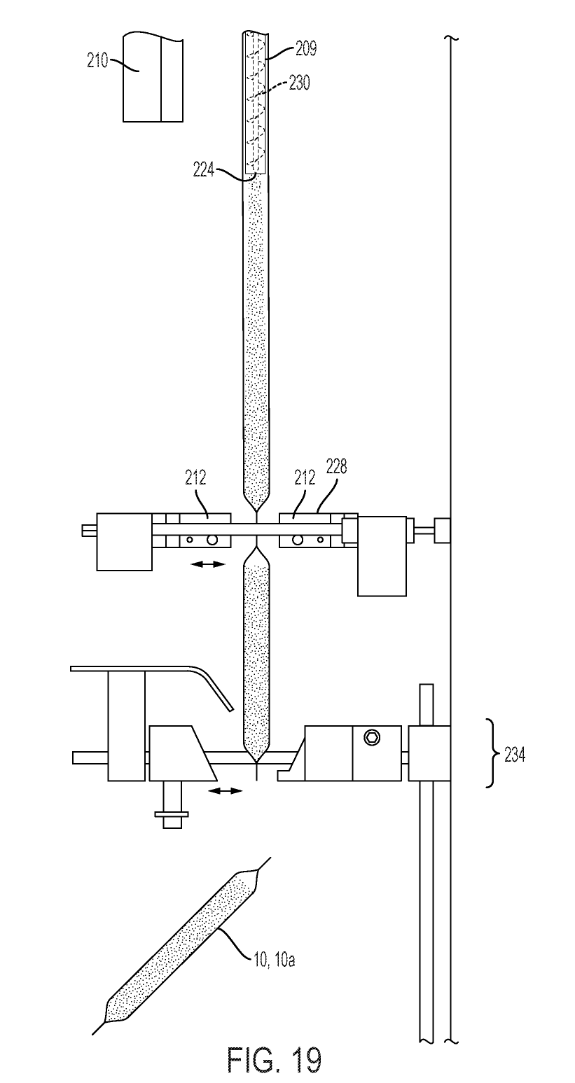

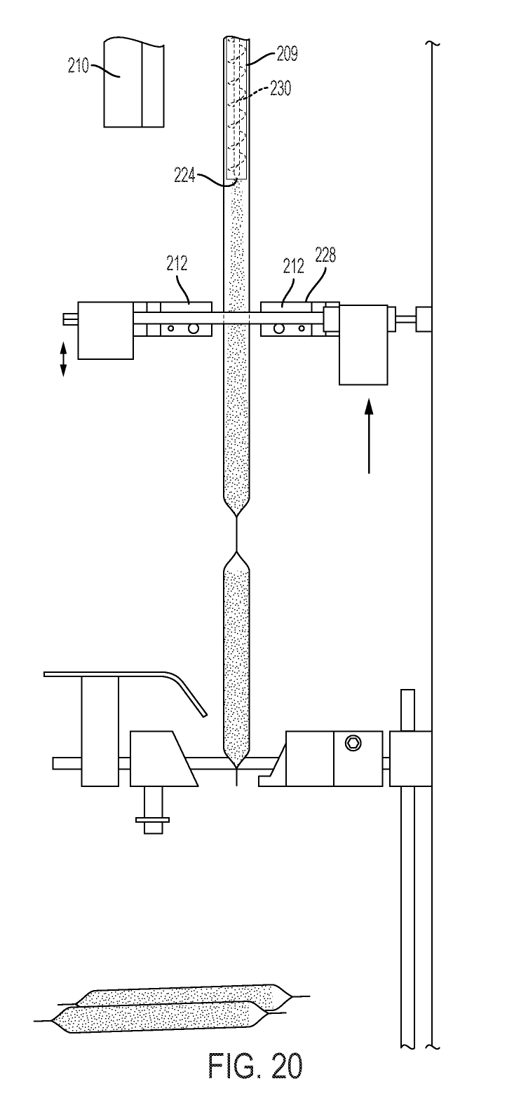

The knife mechanism is opened and the heaters 212 are opened, as shown in FIG. 19. The heaters 212 are also brought back up to the position shown in FIG. 16, as shown in FIG. 20. As shown in FIG. 20, the next packet 10, 10a is being filled so that the cycle is repeated beginning from FIG. 16 to FIG. 20.

The perforator discussed in relation to machine 100 may also be incorporated into the machine 200 for creating packets 10a.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

1-11. (canceled)

12. A method of forming a tube and filling the tube with a powdered nutritional food product to form a packet, the method comprising the steps of:
providing an elongate strip of flat water dissolvable film, the film defining opposed longitudinal edge portions, at least one of the edge portions having a heat activated adhesive layer;
providing a machine for folding the film into a tubular configuration, filling the tubular configured tube with the powdered nutritional food, sealing a longitudinal edge portion of the packet by heating the heat activated adhesive layer and sealing opposed upper and lower end portions of the packet, the machine having:
a hopper;
a tube attached to the hopper, the tube defining a distal end which is disposed within the tubular configured film, the hopper having an augur to facilitate downward movement of the powdered nutritional food product within the tube;
a vertical heating pad traversable between a retracted position and a sealing position for forming the seal along the longitudinal edge portion of the packet;
a horizontal heating pad for forming the seals at the opposed end portions of the tubular configured film, the horizontal heating pad horizontally traversable between a sealing position and a retracted position, the heating pad vertically traversable between an up position and a down position while the heating pad is in the sealing position, the distal end of the tube being positioned about ½ inch to 5 inches vertically above the heating pad when the heating pad is in the up position;
forming the film into a tubular configuration;
traversing the vertical heating pad to form the seal along the longitudinal edge portion of the packet;
disposing the horizontal heating pad in the sealed position to seal a lower end portion of the packet, the heating pad being disposed in the up position;
activating the augur after the heating pad is traversed to the seal position and before the heating pad begins its traversal to the down position so that the distal end of the tube is ½ inch to five inches above the sealed lower end portion of the packet while the powdered nutritional food product is initially dropped into the tubular configured film;
while the powdered nutritional food product is being dropped into the tubular configured film, traversing the horizontal heating pad from the up position to the down position;
traversing the horizontal heating pad from the seal position to the retracted position;
traversing the horizontal heating pad from the bottom position to the up position;
traversing the horizontal heating pad from the up and retracted position to the up and seal position to form the sealed upper end portion of the packet.

13. A method of manufacturing a drop and drink nutritional packet, the method comprising the steps of:
providing a hydroxypropyl methyl cellulose film being dissolvable in still water at 45° F.-50° F. and having a pH of 7.0, the film being coated with a heat activated adhesive;
providing a powdered nutrient being non-dissolvable or dissolvable in still water at 45° F.-50° F. and having a pH of 7.0 at a time longer than that of the hydroxypropyl methyl cellulose film in still water at 45° F.-50° F. having a pH of 7.0, the powdered nutrient having a mesh size no greater than 30 mesh;
forming a tube with the hydroxypropyl methyl cellulose film having a sealed lower end portion, the sealed lower end portion being formed with a set of horizontal heaters, a vertical seal being formed with a vertical heater, the tube defining an inside and an outside;
dropping the powdered nutrient into the film tube for delivering the powdered nutrient into the film tube when the sealed lower end portion is between 0.5 inches to 5 inches below a distal end of a delivery tube and before the sealed lower end is traversed vertically away from the distal end of the delivery tube to minimize the powdered nutrient from becoming airborne;
creating a pressure differential between an inside of the tube and an outside of the tube as the sealed lower end portion is traversed vertically away from the distal end of the delivery tube so that sidewalls of the tube have a concave configuration to further mitigate the powdered nutrient from becoming airborne;
continuing to drop the powdered nutrient into the film tube as the sealed lower end portion is traversed vertically away from the distal end of the delivery tube to further mitigate the powdered nutrient from becoming airborne;
filling the tube with powdered nutrients so that the powdered nutrients is at about 50% to 95% by volume of the packet;
forming an airtight seal at an upper end portion of the tube;
sealing an upper end portion of the film tube with the set of horizontal heaters.

14. The method of claim 13 wherein the powdered nutrient has a mesh size no greater than 80 mesh.

15. The method of claim 14 wherein the film has a thickness of 0.001 inches.

16. The method of claim 13 wherein the powdered nutrient is whey protein.

17. The method of claim 13 wherein the dropping step comprising the step of dropping the powdered nutrient into the film tube when the sealed lower end portion is between 1 inch to 3 inches below the distal end of the delivery tube for delivering the powdered nutrient into the film tube to minimize the powdered nutrient from becoming airborne.

18. The method of claim 13 wherein the dropping step includes a step of rotating an auger disposed with the delivery tube, an end of the auger extending from a hopper to the distal end of the delivery tube.

19. The method of claim 18 wherein the end of the auger is within about 0.5 inches of the distal end of the delivery tube.

20. The method of claim 13 wherein the delivery tube is oriented vertically.

21. A method of manufacturing a drop and drink nutritional packet, the method comprising the steps of:
providing a hydroxypropyl methyl cellulose film being dissolvable in still water at 45° F.-50° F. and having a pH of 7.0, the film being coated with a heat activated adhesive;
providing a powdered nutrient being non-dissolvable or dissolvable in still water at 45° F.-50° F. and having a pH of 7.0 at a time longer than that of the hydroxypropyl methyl cellulose film in still water at 45° F.-50° F. having a pH of 7.0, the powdered nutrient having a mesh size no greater than 30 mesh;
forming a tube with the hydroxypropyl methyl cellulose film having a sealed lower end portion, the sealed lower end portion being formed with a set of horizontal heaters, a vertical seal being formed with a vertical heater;
dropping the powdered nutrient into the film tube for delivering the powdered nutrient into the film tube when the sealed lower end portion is between 0.5 inches to 5 inches below a distal end of a delivery tube to minimize the powdered nutrient from becoming airborne;
creating a pressure differential between an inside of the tube and an outside of the tube as the sealed lower end portion is traversed vertically away from the distal end of the delivery tube so that sidewalls of the tube have a concave configuration to further mitigate the powdered nutrient from becoming airborne;
continuing to drop the powdered nutrient into the film tube as the sealed lower end portion is traversed vertically away from the distal end of the delivery tube to further mitigate the powdered nutrient from becoming airborne;
filling the tube with powdered nutrients so that the powdered nutrients is at about 50% to 95% by volume of the packet;
forming an airtight seal at an upper end portion of the tube;
sealing an upper end portion of the film tube with the set of horizontal heaters.
